(19) United States
(12) Patent Application Publication
(10) Pub. No.: US 2009/0044938 A1
(43) Pub. Date: Feb. 19, 2009

(54) SMART MOTOR CONTROLLER FOR AN ELECTRICAL SUBMERSIBLE PUMP

(75) Inventors: Alexander Crossley, Broken Arrow, OK (US); Jerald R. Rider, Tulsa, OK (US); De Hao Zhu, Claremore, OK (US)

Correspondence Address: BRACEWELL & GIULIANI LLP, P.O. BOX 61389, HOUSTON, TX, 77208-1389, US

(73) Assignee: BAKER HUGHES INCORPORATED, Houston, TX (US)

(21) Appl. No.: 11/840,054

(22) Filed: Aug. 16, 2007

(51) Int. Cl. E21B 47/00; G06G 7/48

(52) U.S. Cl. 166/250.15; 166/53; 703/10

(57) ABSTRACT

A motor controller for an electrical submersible pump production system is coupled to a real-time software model using known correlations and algorithms to model the performance of the production system, including the production equipment and the well, and executes separately from any modeling used to compute operating parameters from downhole measurements for use by the motor controller. The real-time software model receives operating parameter measurements from a data acquisition subsystem and compares the measurements with projected operating parameter values according to the model. Differences between measured and projected values are analyzed to identify operating problems or non-optimal operating conditions, with automatic corrections and/or notifications being triggered.

### BACKGROUND

1. Field of Invention

The present invention is directed, in general, to measurement and control systems for subterranean bore hole equipment and, more specifically, to measurement and control systems providing extended data with regard to operation of electrical submersible pumps.

2. Background

Typically production motor controllers use a very limited set of parameters to control downhole electrical submersible pump (ESP) operation, ignoring a great number of other factors that, for whatever reason, cannot or are difficult to measure, but which are important in regards to the optimization of ESP operation. Optimization of production processes within a wellbore, particularly processes employing artificial lift equipment such as ESPs, requires actual performance data. Measurements relating to the operation of the pump, the motor, and the flow of fluids and/or gases produced by the pump are desired to maintain production at conditions as close to optimal as possible.

Measurement of some parameters associated with the operation of an electrical submersible pump downhole is relatively straightforward. Measurement of pump intake pressure, motor temperature and motor current, for instance, is accomplished with relative ease. Other parameters, however, are very difficult or even impossible to measure during operation, such as motor and/or pump torque, pump intake viscosity and specific gravity, net flowrates, and the like. However, when more parameters are available for consideration in making control decisions, production control and tuning of pump operation for optimal performance is improved. For example, in some cases the individual value of a particular parameter does not necessarily indicate that anything is wrong with the operation of the ESP. However, a combination or trend of several parameters may indicate such a problem.

There is, therefore, a need in the art for a system providing an enhanced set of parameters relating to the operation of artificial lift equipment for use in production control.

### SUMMARY OF INVENTION

To address the above-discussed deficiencies of the prior art, it is a primary object of the present invention to provide, for use in a borehole production system, real-time software models using correlations and algorithms to model the performance of the production system, including the production equipment and the well. The real-time software model is coupled to a motor controller for an ESP within the production system. The real-time software model receives operating parameter measurements from a data acquisition subsystem and compares the measurements with projected operating parameter values according to the model. The real-time model is then adjusted, if necessary, to match the operating parameter measurements in order to produce a model reflecting actual system performance. Differences between measured and projected values are analyzed to identify operational problems or non-optimal operating conditions. Once the reason for the difference is assessed, the present invention determines whether the ESP system is still operating within predetermined parameters and acts accordingly, such as, for example, performing automatic system corrections or triggering notifications.

### BRIEF DESCRIPTION OF DRAWINGS

Some of the features and benefits of the present invention having been stated, others will become apparent as the description proceeds when taken in conjunction with the accompanying drawings, in which:

FIG. 1 depicts a borehole production system including a smart motor controller according to an exemplary embodiment of the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be through and complete, and will fully convey the scope of the invention to those skilled in the art. Like numbers refer to like elements throughout.

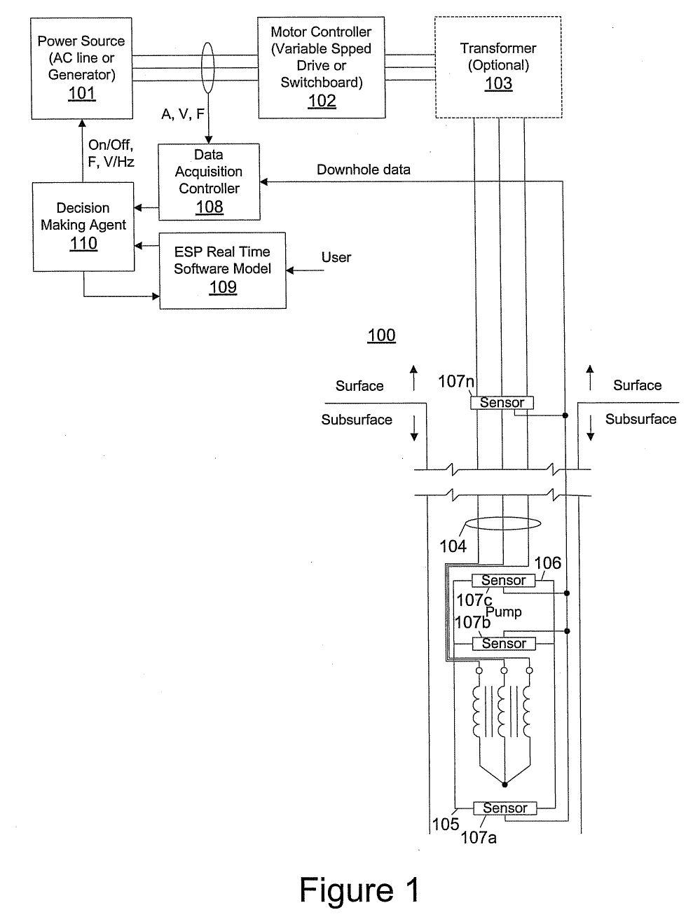

FIG. 1 depicts a borehole production system including a smart motor controller according to one exemplary embodiment of the present invention. The downhole production system 100 includes a power source 101 comprising an alternating current power source such as an electric power line (coupled to a local power utility) or a generator coupled to an providing three phase power to a motor controller 102 such as a pulse width modulated (PWM) variable frequency drive (VFD) or a switchboard or other equivalent controller. Both power source 101 and motor controller 102 are located at the surface of a borehole and are coupled by an optional transformer 103 and a three phase power transmission cable 104 to an induction motor 105 disposed within the borehole by connection to tubing (not shown) lowered within the well casing.

The downhole production system 100 also includes artificial lift equipment for aiding production, which comprises induction motor 105 and, in the exemplary embodiment, an electrical submersible pump 106, which may be of the type disclosed in U.S. Pat. No. 5,845,709. Motor 105 is mechanically coupled to and drives the pump 106, which induces flow of gases and fluids up the borehole. Cable 104, motor 105 and pump 106, together with a seal (not shown), preferably form an electrical submersible pump (ESP) system.

Downhole production system 100 also includes a data acquisition, logging (recording), and control system, which comprises sensors 107a-107n (which may include any number of sensors) and a data acquisition controller 108. Sensors 107a-107n are located downhole within or proximate to motor 105 or pump 106, or at other locations within the borehole (e.g., at the wellhead of a subsea borehole). Sensors 107a-107n monitor various conditions within the borehole, such as vibration, ambient wellbore fluid temperature, ambient wellbore fluid pressure, motor voltage and/or current, motor speed (revolutions per minute), motor oil pressure, motor oil temperature, pump intake pressure, fluid pressure at one or more stages of the pump, fluid temperature at one or more stages of the pump, pump speed, pump output pressure, pump output flow rate, pump output fluid temperature and the like.

Sensors 107a-107n communicate respective measurements on at least a periodic basis to controller 108 utilizing known techniques, such as, for example, those disclosed in commonly-assigned U.S. Pat. Nos. 6,587,037, entitled METHOD FOR MULTI-PHASE DATA COMMUNICATIONS AND CONTROL OVER AN ESP POWER CABLE, filed May 5, 2000; and 6,798,338, entitled RF COMMUNICATION WITH DOWNHOLE EQUIPMENT, filed Jul. 17, 2000. The content of the above-identified applications is incorporated herein by reference.

Controller 108 may similarly communicate control signals to either the motor 105, the pump 106, or both, or to other downhole components utilizing the techniques described in the above-identified applications. Such 20 control signals regulate operation of the motor 105 and/or pump 106 (or other components) to optimize production in accordance with known techniques.

Data acquisition controller 108 may also be coupled to the output of motor controller 102 to receive measurements of amperage, voltage and/or frequency regarding the three phase power being transmitted downhole. In addition, downhole production system 100 further includes a separate computer running an ESP real time software model 109 (with both hardware and software represented by box 109). The ESP real time software model 109 is capable of performing real time calculations modeling the behavior of the ESP systems, including the motor 105, the pump 106, the well and the reservoir using algorithms and correlations, such as, for example, those disclosed in Kermit E. Brown, Technology of Artificial Lift Methods, Volume I, with the end effect of either optimizing production of oil/water wells and/or increasing the run life of the equipment. In addition, a user may make manual adjustments to the software model to reflect information from other wells in the same reservoir or the like.

The software model 109 runs in addition to any modeling performed within or in direct connection with motor controller 102, including, for example, any simulations for deriving parameters from measured parameters as disclosed in commonly-assigned co-pending U.S. patent application Ser. No. 09/911,298, entitled VIRTUAL SENSORS TO PROVIDE EXPANDED DOWNHOLE INSTRUMENTATION FOR ELECTRICAL SUBMERSIBLE PUMPS (ESPs), filed Jul. 23, 2001, the content of which is hereby incorporated by reference. A decision making agent 110 receiving both data from data acquisition controller 108 and optimal performance values from software model 109 can control the power source 101 by controlling such parameters as on/off, frequency (F), and/or voltages each at one of a plurality of specific frequencies (V/Hz). The decision making agent 110 may execute within the same hardware as the data acquisition controller 108 and/or the real-time software model 109, or each component may operate in a separate hardware element. The decision making agent 110 receives inputs from at least the data acquisition controller 108 and the real-time software model 109 and produces control signals, which are transmitted to one or more of the motor controller 102, the real-time software model 109 or elsewhere for further processing and/or evaluation.

By having a real time model of the system available, together with “real” data provided by the data acquisition agent or derived from measurements as described above, the decision making agent 110 can compare the “real” data and the modeled data to make adjustments to the real time model to match measured parameters or conditions, if necessary. The decision making agent 110 can automatically determine the reason for the difference, if any, between the measured data and corresponding projected parameter values under the model, including possible pump failure, changes in pump performance (e.g., due to wear), and/or changes in the well performance (e.g., the productivity index, gas production or water cut). In addition, the decision making agent 110 may even detect faulty data acquisitions sensors among sensors 107a-107n.

Once the reason for any difference(s) between measure and projected data is identified, the decision making agent 110 may utilize an expert system (not separately shown) to determine whether the production system as a whole is still within the predetermined operating parameters, and take remedial action as necessary. The result from the decision making agent 110 may be to change the operating parameters of the motor controller 102, such as frequency, overload limits, and/or underload limits, with the purpose of optimizing well production or increasing pump efficiency. Alternatively, the decision making agent 110 may start/stop the controller 102 with the purpose of protecting the controller 102, the pump 106 or any other component of the production system (including the reservoir). Still further, decision making agent 110 may start/stop the controller 102 with the purpose of properly controlling the “draw-down” rate when using intermittent operation of the pump 106. In addition, the decision making agent 110 may also flag any anomalous operating conditions and automatically page or otherwise send a notification to a human operator.

During operation, data from the data acquisition controller 108, the software model 109, and/or the decision making agent 110 may be logged and/or transmitted (e.g., by Internet or other data communications network, not shown) to a central location for further analysis or historical purposes. In addition, such data may be transmitted to a central location for field analysis and optimization by applying the real time model on a per-well basis within a multi-well production field.

As noted above, the software model 109 of the production system is based on correlations and algorithms. One feature, however, is that calculations within software model 109 may be performed in a continuous, uninterrupted mode to permit dynamic analysis, without having to suspend model calculations and processing in order to directly control the production system. Software modeling is run concurrently with and in parallel to any control system modeling calculation.

As a specific example of how software model 109 can improve performance, an ESP production system that does not include a motor temperature probe (or one that has a faulty probe) could lead to a burnt motor during initial drawdown because the coolant (well fluid) is initially provided almost exclusively from fluid trap in the annular space between the motor 105 and the well casing rather than from the perforations. Using software model 109, which permits continuous monitoring of the modeled motor temperature, the motor controller 102 can be stopped or frequently reduced during drawdown if such real-time calculated motor temperature ever exceeds a preprogrammed limit, thus protecting the system against failure and reducing lifetime operating costs.

In an alternative example, the production system may suffer damage to the pump 106 (e.g., severe downthrust) if the surface valve is closed or the tubing is plugged for whatever reason. The system 100 automatically detects that condition from differences between measured and computer parameter values, (e.g., analysis of pressure and current values), then proceeds with an automatic shutdown and transmits a notification of the pump condition to a central location, or page a field operator. These and many other conditions requiring real-time analysis for proper diagnosis are encompassed by the production system 100.

An electrical submersible pump production system is provided with a real-time software model for the production equipment, the well and the reservoir executing in parallel with any control software (and hardware) for controlling pump and well operation and/or sensor performance. Production can be optimized by comparing parameter measurements from sensors and/or computed parameter values derived from such measurements with projected (or computed) values for the corresponding parameters under the modeled performance of the production equipment, the well, etc. Based on such comparisons, problems with the production equipment or operation that is not optimal (or outside a predetermined measure from optimal operation) for current well conditions may be automatically adjusted. Notifications may also be automatically sent to initiate manual intervention.

A motor controller within an ESP production system includes or is associated with a capability for comparing actual performance of the entire production system to one or more system models running simultaneously or in real-time. The output of this comparison is utilized to troubleshoot, optimize or protect the production system and its components (including the well and reservoir). The output may also be transmitted to a central or remote location for further processing. This solves the problem of how to include difficult-to-obtain ESP system parameters as criteria for motor controller operation and adjustments, and may be utilized to optimize systems as a whole including well production, motor and pump operation, and motor controller optimum settings.

It is important to note that while embodiments of the present invention have been described in the context of a fully functional system and method embodying the invention, those skilled in the art will appreciate that the mechanism of the present invention and/or aspects thereof are capable of being distributed in the form of a computer readable medium of instructions in a variety of forms for execution on a processor, processors, or the like, and that the present invention applies equally regardless of the particular type of signal bearing media used to actually carry out the distribution. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, and other newer types of memories, and transmission type media such as digital and analog communication links. For example, such media can include both operating instructions and/or instructions related to the system and the method steps described above.

It is to be understood that the invention is not limited to the exact details of construction, operation, exact materials, or embodiments shown and described, as modifications and equivalents will be apparent to one skilled in the art. In the drawings and specification, there have been disclosed illustrative embodiments of the invention and, although specific terms are employed, they are used in a generic and descriptive sense only and not for the purpose of limitation. Accordingly, the invention is therefore to be limited only by the scope of the appended claims.

What is claimed is:

1. A borehole production control system comprising:
a motor controller controlling delivery of power to a pump motor within a borehole;
a data acquisition system supplying data for one or more parameters relating to operation of the production system;
a system executing a real-time software model for a production system including the pump motor and motor controller that computes projected values for parameters corresponding to the data; and
an agent operating on an output from the data acquisition system and an output from the real-time software model in controlling at least a power source supplying power to the motor controller.

2. The borehole production control system according to claim 1, wherein the agent compares the data to the projected values to identify one or more of possible equipment failure, changes to equipment performance, changes to well performance and/or non-optimal equipment operation.

3. The borehole production control system according to claim 1, wherein the agent changes an operating parameter of one or more of the power source and the motor controller.

4. The borehole production control system according to claim 3, wherein the agent changes one or more of an on/off operating condition, an output frequency, and voltage levels at each of multiple frequencies for the power source, and wherein the agent changes one or more of an output frequency, an overload limit and an underload limit of the motor controller to increase pump efficiency or to improve production optimization.

5. The borehole production control system according to claim 3, wherein the agent stops the motor controller as warranted to control drawdown during intermittent pump operation and wherein the agent automatically flags anomalous operating conditions and/or automatically sends a notification regarding operating conditions to one or more of a remote system and a human operator.

6. A method of controlling a borehole production system comprising:
controlling a delivery of power to a pump motor within a borehole;
supplying data for one or more parameters relating to operation of the production system;
executing a software model for a production system including the pump motor and motor controller that computes projected values for parameters corresponding to the data; and
controlling at least a power source supplying power to the motor controller based upon an output from the data acquisition system and an output from the software model.

7. The method according to claim 6, further comprising comparing the data to the projected values to identify one or more of possible equipment failures, changes to equipment performance, changes to well performance and/or non-optimal equipment operation.

8. The method according to claim 6, further comprising changing an operating parameter of one or more of the power source and the motor controller.

9. The method according to claim 8, further comprising changing one or more of an on/off operating condition, an output frequency, and a voltage level at each of multiple frequencies for the power source.

10. The method according to claim 8, further comprising changing one or more of an output frequency, an overload limit and an underload limit of the motor controller to increase pump efficiency or to improve production optimization.

11. The method according to claim 8, further comprising stopping the motor controller as warranted to protect one or more of the motor controller and the well from damage.

12. The method according to claim 8, further comprising stopping the motor controller as warranted to control drawdown during intermittent pump operation.

13. The method according to claim 8, further comprising automatically flagging anomalous operating conditions and/or automatically sending a notification regarding operating conditions to one or more of a remote system and a human operator.

14. The method according to claim 6, where one or more of the data, the projected values, any comparisons between the measured data and the projected values, and any operating conditions derived from the data and the projected values are logged and transmitted to a remote location for further analysis.

15. A method according to claim 6, further comprising executing the software model on a system also forming or executing the motor controller.

16. A computer readable medium that is readable by a computer, the computer readable medium comprising a set of instructions that, when executed by a computer, causes the computer to perform the following operations:
controlling a delivery of power to a pump motor within a borehole;
supplying data for one or more parameters relating to operation of the production system;
executing a software model for a production system including the pump motor and motor controller that computes projected values for parameters corresponding to the data; and
controlling at least a power source supplying power to the motor controller based upon an output from the data acquisition system and an output from the software model.

17. The computer readable medium of claim 16, further comprising a set of instructions that, when executed by a computer, causes the computer to perform the operation of comparing the data to the projected values to identify one or more of possible equipment failures, changes to equipment performance, changes to well performance and/or non-optimal equipment operation.

18. The computer readable medium of claim 16, further comprising a set of instructions that, when executed by a computer, causes the computer to perform the operation of changing an operating parameter of one or more of the power source and the motor controller.

19. The computer readable medium of claim 18, further comprising a set of instructions that, when executed by a computer, causes the computer to perform the operation of changing one or more of an on/off operating condition, an output frequency, and a voltage level at each of multiple frequencies for the power source and changing one or more of an output frequency, an overload limit and an underload limit of the motor controller to increase pump efficiency or to improve production optimization.

20. The computer readable medium of claim 16, further comprising a set of instructions that, when executed by a computer, causes the computer to perform the operation wherein one or more of the data, the projected values, any comparisons between the measured data and the projected values, and any operating conditions derived from the data and the projected values are logged, transmitted to a remote location for further analysis, and/or transmitted to a central location for analysis in conjunction with data relating to other wells.
